(19) United States
(12) Patent Application Publication
(10) Pub. No.: US 2026/0171797 A1
(43) Pub. Date: Jun. 18, 2026

(54) NETWORK ARCHITECTURE HAVING PARALLEL REDUNDANCY FOR COMMUNICATION IN DC ENERGY STORAGE SYSTEMS

(71) Applicant: Fluence Energy, LLC, Arlington, VA (US)

(72) Inventor: Balakrishanmraju Motapothula, BANGALORE (IN)

(73) Assignee: Fluence Energy, LLC, Arlington, VA (US)

(21) Appl. No.: 19/420,022

(22) Filed: Dec. 15, 2025

Related U.S. Application Data
(60) Provisional application No. 63/734,741, filed on Dec. 16, 2024.

(51) Int. Cl. H02J 3/001; H02J 3/32; H02J 103/30

(52) U.S. Cl. CPC H02J 3/001; H02J 3/32; H02J 2103/30

(57) ABSTRACT

A power plant having a plurality of DC battery energy storage system (BESS) modules is disclosed, with each BESS module having a dually attached node (DAN); a plant controller; and a communication network. The communication network is linked between the plurality of BESS modules and the plant controller. The communication network includes a redundant local area network (LAN) arranged with a first LAN and a second LAN. The DAN of each of the plurality of BESS modules is in communication with the plant controller via the first LAN and via the second LAN. The communication network executes a parallel redundancy protocol (PRP) to effect communication between the plant controller and the plurality of BESS modules via the first and second LANs and the DAN.

### CROSS-REFERENCE TO RELATED APPLICATIONS

This application claims the benefit of U.S. Provisional Patent Application No. 63/734,741, filed on Dec. 16, 2024, the disclosure of which is hereby incorporated by reference.

### INTRODUCTION

The concepts described herein relate generally to DC (direct current) battery energy storage systems (BESSs), and more specifically, to modular DC energy storage systems that supply electric power to an electric grid.

Known BESSs have a communication network that may include core switches that are connected to nodes that correspond to DC energy storage devices, or batteries. Occurrence of a fault in one of the core switches or a link in the communication network may cause a data loss from the nodes corresponding to the plurality of DC energy storage devices. A fault may lead to deactivation of the corresponding plurality of DC energy storage devices. A fault may be in the form of a permanent fault, an intermittent fault, or a single event fault. Network recovery may take a few milliseconds to a few seconds, possibly even minutes.

There are benefits for a BESS having a fault-tolerant communication network.

### SUMMARY

The concepts described herein provide a DC battery electric energy storage system (BESS) having a fault-tolerant communication network that has zero-recovery-time redundancy. The BESS may be sized to supply electrical power to an electric grid, e.g., a public grid, a local industrial grid, a personal grid, etc., when connected via a main circuit breaker.

An aspect of the disclosure may include a power plant having a plurality of DC battery energy storage system (BESS) modules, each BESS module having a dually attached node (DAN); a plant controller; and a communication network. The communication network is linked between the plurality of BESS modules and the plant controller; the communication network includes a redundant local area network (LAN) arranged with a first LAN and a second LAN; the DAN of each of the plurality of BESS modules is in communication with the plant controller via the first LAN; the DAN of each of the plurality of BESS modules is in communication with the plant controller via the second LAN; and the communication network executes a parallel redundancy protocol (PRP) to effect communication between the plant controller and the plurality of BESS modules via the first and second LANs and the DAN.

Another aspect of the disclosure may include each DAN having a first end node and a second end node; wherein the parallel redundancy protocol (PRP) is arranged to send a first message packet from the plant controller to one of the plurality of BESS modules via the first LAN and the first end node of the DAN, and send a duplicate of the first message packet from the plant controller to the one of the plurality of BESS modules via the second LAN and the second end node of the DAN. The DAN accepts one of the first message packet or the duplicate of the first message packet from the plant controller; and discards the other of the first message packet or the duplicate of the first message packet from the plant controller.

Another aspect of the disclosure may include the parallel redundancy protocol (PRP) being arranged to monitor the first LAN and the second LAN; and, upon detecting a fault in one of the first LAN or the second LAN, discontinue sending the first message packet from the plant controller to the one of the plurality of BESS modules via the one of the first LAN or the second LAN in which the fault has been detected.

Another aspect of the disclosure may include a network topology for the communication network including the first LAN and the second LAN being arranged as a linear topology.

Another aspect of the disclosure may include a network topology for the communication network including the first LAN and the second LAN being arranged as a star topology.

Another aspect of the disclosure may include a network topology for the communication network including the first LAN and the second LAN being arranged as a ring topology.

Another aspect of the disclosure may include the redundant local area network (LAN) with the first LAN and the second LAN being arranged to communicate in parallel.

Another aspect of the disclosure may include a communication network having a dually attached node (DAN) that is incorporated into a battery energy storage system (BESS) module; and a redundant local area network (LAN) having a first LAN and a second LAN; wherein the DAN of the BESS module is in communication with a plant controller via the first LAN; and wherein the DAN of the BESS module is in communication with the plant controller via the second LAN in parallel with the first LAN.

Another aspect of the disclosure may include the communication network being configured to execute a parallel redundancy protocol (PRP) to effect communication between the plant controller and the BESS module employing the first LAN and the second LAN.

Another aspect of the disclosure may include a method for communicating in a power plant, including arranging a plurality of DC battery energy storage system (BESS) modules, wherein each BESS module has a dually attached node (DAN); linking, via a communication network, a plant controller to the BESS modules, wherein the communication network includes a redundant local area network (LAN) arranged with a first LAN and a second LAN; and executing a parallel redundancy protocol (PRP) to effect communication between the plant controller and the plurality of BESS modules via the first and second LANs and the DAN; wherein the DAN of each of the plurality of BESS modules is in communication with the plant controller via the first LAN; and wherein the DAN of each of the plurality of BESS modules is in communication with the plant controller via the second LAN.

The parallel redundancy protocol (PRP) includes sending a first message packet from the plant controller to one of the plurality of BESS modules via the first LAN and a respective one of the DANs, and sending a duplicate of the first message packet from the plant controller to the one of the plurality of BESS modules via the second LAN and a respective one of the DANs, and accepting, at the respective one of the DANs, one of the first message packet or the duplicate of the first message packet from the plant controller. The other of the first message packet or the duplicate of the first message packet from the plant controller is discarded at the respective one of the DANs.

The above summary is not intended to represent every possible embodiment or every aspect of the present disclosure. Rather, the foregoing summary is intended to illustrate some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates an embodiment of a power plant including a battery energy storage system (BESS) module having a plurality of BESS enclosures in operative in communication with and operably connected to an energy system, e.g., an electric grid, in accordance with the disclosure.

FIG. 2 schematically illustrates an embodiment of an energy storage system including a plurality of rechargeable BESS modules, in accordance with the disclosure.

FIG. 3 schematically illustrates elements of a communication network for an energy storage system including a plurality of rechargeable BESS modules, in accordance with the disclosure.

FIG. 4 schematically illustrates elements of a communication network for an energy storage system including a plurality of rechargeable BESS modules that is arranged in a ring topology, in accordance with the disclosure.

FIG. 5 is a partially schematic perspective-view illustration of a representative energy storage system in accord with aspects of the present disclosure.

FIG. 6 is a partially schematic front-view illustrations of the representative energy storage system of FIG. 5.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments may be practiced without some of these details. Moreover, for the purpose of clarity, certain technical material that is understood in the related art has not been described in detail to avoid unnecessarily obscuring the disclosure.

Furthermore, the drawings are in simplified form and are not to precise scale. For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description is merely illustrative in nature and is not intended to limit the application and uses. Furthermore, there is no intention to be bound by expressed or implied theory presented herein. Throughout the drawings, corresponding reference numerals indicate like or corresponding parts and features.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

The use of ordinals such as first, second and third does not necessarily imply a ranked sense of order, but may distinguish between multiple instances of an act or structure.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which may be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter may have a discrete value, e.g., either “1” or “0”, or may be infinitely variable in value.

An energy system may include, for example, a system arranged to generate, transmit, convert, distribute, store, and/or use energy (e.g., electrical energy) and/or associated with another aspect of energy. As one example, an energy system may include an electric grid. An electric grid may include, for example, an interconnected network for electric power delivery from producers to consumers. An electric grid may include, for example, power stations (e.g., thermal power stations, photovoltaic power stations, solar farms, wind power stations, wind farms, hydroelectric power stations, etc.), substations (e.g., for transforming voltage from higher to lower voltage levels, or from lower to higher voltage levels, or for performing other functions associated with transmitting electrical energy between producers and consumers), electrical power transmission and/or distribution (e.g., transmitting electrical energy from producers to substations, and/or delivering electrical energy from a transmission system to consumers), and/or other elements.

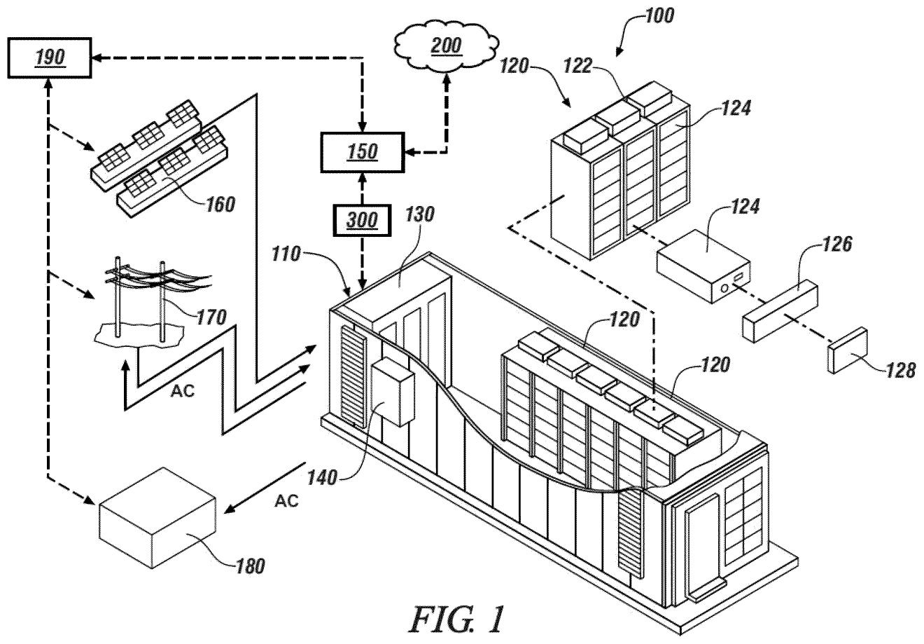

Referring to the drawings, wherein like reference numbers refer to the same or like components in the several Figures, FIG. 1 schematically illustrates a topology for a power plant 100 including a BESS module 110 having a plurality of nodes or BESS enclosures 120, a power conversion system 130, and a thermal management system 140, and may be employed to supply electric power to an electric grid.

A substation controller 190 communicates with BESS controller 150 to operate and monitor the power plant 100 including but not limited to receiving commands from a customer and converting the commands into BESS controls and site-specific commands.

The BESS controller 150 communicates with the BESS module 110, which is linked via a communication network 300. The BESS controller 150 employs algorithms, calibrations, sensors, and actuators to monitor and control the various components included in the BESS module 110.

Each of the plurality of BESS enclosures 120 includes a battery rack 122 having a plurality of battery packs 124. Each of the plurality of battery packs 124 includes a plurality of battery modules 126 having a plurality of batteries 128 arranged within each of the plurality of battery modules 126.

The plurality of BESS enclosures 120 are coupled to one another via power buses, and are collectively coupled to a power conversion system 130. The plurality of BESS enclosures 120, individually and collectively, are operable to store alternating current (AC) power delivered from an external power source 160 as direct current (DC) power, for example but not limited to when the demand for power from the external power source 160 is lower than the external power source 160 is capable of generating, and/or to provide DC power for an electrical application, which may include an electrical grid 170, for example but not limited to when the demand for power is higher than the external power source 160 is capable of generating. The plurality of BESS storage enclosures 120 may be coupled to one another electrically, mechanically, and/or fluidly.

To facilitate the conversion of AC power to DC power and DC power to AC power, the power conversion system 130 is configured to standardize power input and output between the plurality of BESS enclosures 120 and the external power source 160. The power conversion system 130 may include, for example but not limited to, one or multiple power converters (or inverters) configured to convert AC power to DC power, and/or DC power to AC power.

According to one aspect of the disclosure, the BESS module 110 is configured to provide power to an auxiliary power system 180, which may include but is not limited to battery and power converter thermal management 140, control systems, communications etc.

In some embodiments, the battery system of FIG. 1 contains one or more modular BESS nodes, for example, to provide energy storage for load levelling of an electrical grid or energy storage for transient sources of electrical energy, such as solar cells or wind turbine generators. Each BESS node may include a protective, weather-resistant BESS enclosure within which are stored the energy storage devices and attendant componentry of the BESS 100. The BESS enclosure may house, in one embodiment, a row of (six) battery racks that each supports thereon a set of (eight) battery packs. Each battery pack contains a stack of (sixteen) rechargeable battery cells, such as lithium-ion, sodium-ion, or vanadium flow cells, and a bottom-layer battery module unit (BMU) that functions as a supervisory component for monitoring and coordinating operation of the battery cells. Packaged on top of each rack is a middle-layer battery cluster management (BCM) unit that sits at the middle tier of the BESS's hierarchical Battery Management System (BMS) for receiving and processing data from the multiple BMUs within its designated battery cluster. Located at opposing ends of the BESS enclosure, adjacent the storage cabinets that stow the battery racks, are two self-contained hardware bays for housing auxiliary components that support the efficient functioning of the BESS node. For instance, bay may house a heating, ventilating, air conditioning (HVAC) system that governs the internal operating temperatures inside the cabinets where the battery packs are located. Hardware bay may also house a chiller for selectively chilling coolant that is circulated to the battery packs in order to maintain the battery cells within their specified operational temperature ranges. Located at the opposite end of the BESS enclosure, is a bidirectional power transformer that boosts (“steps-up”) voltage output by the battery cells to a level suitable for the grid or other components within the system, or decreases (“steps-down”) incoming voltage for recharging the battery cells.

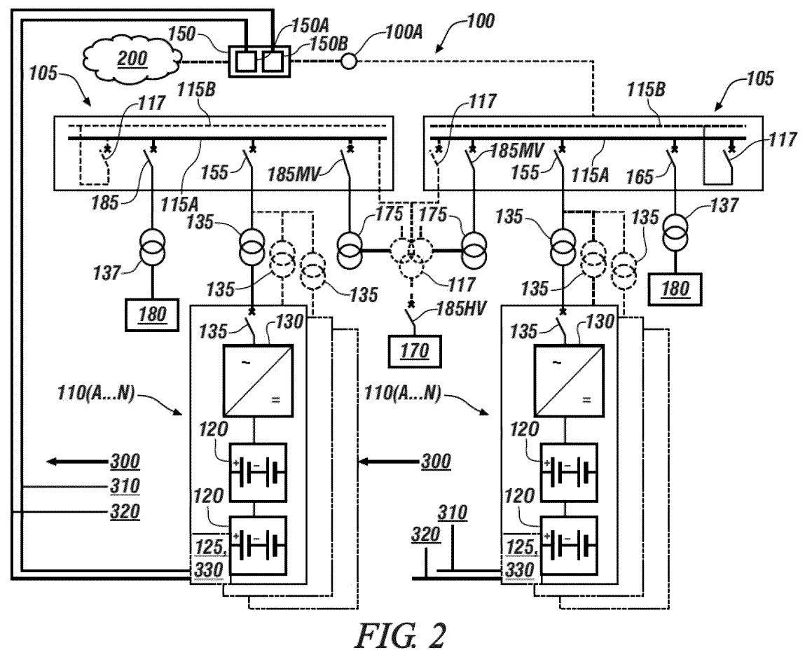

As schematically illustrated in FIG. 2 with continued reference to FIG. 1, an embodiment of a topology for a power plant 100 for supplying electric power to an electric grid 170 includes a plurality of battery energy storage system (BESS) modules 110 (A . . . N), BESS controller 150, substation controller 190, and communication network 300.

The power plant 100 is advantageously arranged in a plurality of arrays 105 with each of the plurality of arrays 105 having a plurality of BESS modules 110 (A . . . N) including BESS enclosures 120, a first power bus bar 115A, a second power bus bar 115B, BESS enclosure circuit breakers 135, BESS circuit breakers 155, and BESS transformers of the power conversion system 130.

The first and second power bus bars 115A, 115B are redundant, thus enabling electric power flow to the BESS modules 110 (A . . . N) in accordance with the selected operating mode.

Bus couplers 117 are arranged between the first power bus bar 115A and the second power bus bar 115 to operably connect the first bus 115A to the second power bus bar 115B, and between the respective first bus bars 115A of each array 105.

Medium voltage (MV) main circuit breakers 185MV are arranged between the second power bus bar 115B and transformers 175, a three-phase transformer 177 is arranged between the transformers 175, and a high voltage (HV) main circuit breaker is arranged between the three-phase transformer 177 and an electric grid to operably connect arrays 105 to the electric grid 170.

Each BESS module 110 (A. . . . N) has one or multiple nodes, and each node represents a rechargeable BESS enclosure 120. Alternatively, a single bus bar may be implemented and employed for enabling electric power flow to the BESS modules 110 (A. . . . N) in accordance with the selected operating mode.

Each array 105 of BESS modules 110 (A. . . . N) is controllable by the BESS plant controller 150 to selectively connect the respective BESS 100 to the first power bus bar 115A via respective BESS circuit breakers 155.

Each BESS module 110 (A. . . . N) advantageously includes one of or a plurality of rechargeable BESS enclosures 120, power conversion system 130, internal disconnect circuit breakers 135, one or multiple sensors (not shown), and the thermal management system 140, in one embodiment.

Each of the BESS modules 110 (A. . . . N) is selectively connectable to an electric grid 170 and/or the auxiliary power system 180 of the power plant 100 by action of the plant controller 150.

The array 105 is one form of a modular energy storage system having multiple BESS modules 110 (A. . . . N) that are interconnected.

Each BESS module 110 (A. . . . N) is selectively electrically connectable to the first power bus bar 115A and respective BESS circuit breaker 155 to supply electric power to the electric grid 170 via the respective BESS circuit breaker 155, by action of the plant controller 150, as detailed with reference to the embodiments illustrated herein.

Each BESS module 110 (A. . . . N) is couplable to an external power source 160, the electric grid 170, or the auxiliary power system 180 to effect charging. The external power source 160 may originate from solar, wind, geothermal, nuclear, natural gas, coal, diesel fuel, methane, biofuel, or another energy source.

The BESS modules 110 (A. . . . N) include one of or a plurality of BESS enclosures 120, which are DC energy storage devices (or batteries) that include one or more rechargeable electrochemical cells. The rechargeable electrochemical cells may include one or more of various types of batteries, such as lithium-ion batteries, lithium iron phosphate batteries, silver-oxide batteries, nickel-zinc batteries, nickel metal hydride batteries, lead-acid batteries, nickel-cadmium batteries, lithium nickel manganese cobalt oxides (NMC) batteries, lithium nickel cobalt aluminum oxides (NCA) batteries, lithium ion manganese oxide (LMO) batteries, lithium cobalt oxide batteries, fuel cells, or other types of batteries. Alternatively, or in addition, the DC energy storage devices may be in the form of ultracapacitors, flywheels, fuel cells, etc., without limitation.

Each BESS enclosure 120 may have control components associated therewith. The control components may be, for example, configured to individually manage the charge and discharge of each of the batteries. The control components may include, for example, battery management systems (BMS). In some examples, each of the batteries may have a dedicated on-board control component (e.g., a battery management system). The control component for each of the batteries may be implemented by a computing device, and/or may communicate with a central management controller, e.g., module controller 125. Additionally, or alternatively, the central management component may manage the charge and discharge of the batteries collectively. The charge and discharge of the batteries of the BESS modules (A. . . . N) may be controlled via module controller 125 using devices and control algorithms, such as circuits with circuit breaker controls, charge or discharge controllers, charge or discharge regulators, battery regulators, and/or the like, so that each of the batteries may be controlled to be in a state of receiving electric power from a source at a particular rate, in a state of outputting electric power to a load at a particular rate, or in a state of being idle or disconnected.

Each of the BESS modules 110 (A. . . . N) includes the power conversion system 130. The power conversion system 130 may refer to, for example, a system that is operable to convert electric power from one form to another form. For example, the a power converter of the power conversion system 130 may be configured to convert alternating current (AC) to direct current (DC), convert direct current to alternating current, convert an alternating current at a first frequency and/or magnitude to another alternating current at a second frequency and/or magnitude, convert direct current at a first magnitude to direct current at a second magnitude, etc.

In some examples, the power conversion system 130 may include DC to AC conversion, e.g., using a power inverter, and/or may include AC to DC conversion, e.g., using a rectifier. As one example, the batteries may output electrical energy in the form of direct current, which the power converter may convert into alternating current, e.g., for supplying to a power line or electric grid operating with alternating current. As another example, the power converter may convert alternating current, e.g., received from a power line or electric grid operating with alternating current into direct current for inputting to or charging the batteries. Additionally, or alternatively, the power converter may include AC to AC conversion (via a transformer) and/or may include DC to DC conversion (via a rectifier). The power converter may be configured to convert electrical energy from the batteries into a form for outputting, e.g., to a load, and/or may be configured to convert electrical energy from another source into a suitable form for inputting to or charging of the batteries. For example, the power converter may be used for coupling the batteries to a power bus or an electric grid. In some examples, the power converter may include a structure or component that may be applicable to the batteries collectively. In some examples, the power converter may include multiple structures or components each of which may be respectively applicable to a corresponding battery of the batteries. In some examples, the power converter may include a structure or component that may be applicable to some of the batteries collectively, and the power converter may include multiple structures or components each of which may be respectively applicable to a corresponding battery or sets of batteries. In some examples, a power conversion system may be used for multiple energy storage modules collectively (e.g., for converting electrical energy from multiple energy storage modules into a desired form for outputting to a load, or for converting electrical energy from a source into a desired form for inputting to or charging the multiple energy storage modules.

The thermal management system 140 may include a type of device configured to remove and/or add heat to the BESS modules 110 (A. . . . N) and the power converter. The thermal management system may use air, liquid, solid material, gaseous material, and/or another type of suitable medium or material to remove heat employing conductive heat transfer, convective heat transfer, radiant heat transfer, or another form of heat transfer. In some examples, the thermal management system may include heat sinks and/or thermal management fins. In some examples, the thermal management system may include fans (e.g., for moving air in air-cooling), pumps (e.g., for moving a liquid in liquid-cooling), compressors (e.g., for vapor-compression refrigeration), or another type of device for thermal management. The thermal management system may have a desired configuration (e.g., shape, size, weight, functionality, etc.), and/or may be disposed, placed, oriented, or distributed in association with sensors and the power converter. In some examples, the computing device may control the components based on instructions from another computing device (e.g., the energy storage controller device). Additionally, or alternatively, data associated with the BESS modules 110 (A. . . . N) may be recorded or stored, including, for example, data measured by the sensors, data used by the BESS modules 110 (A. . . . N), e.g., parameters for controlling the batteries, parameters for controlling the power conversion system 130, or parameters for controlling the thermal management system 140, or another type of data. The recorded or stored data may be used or processed by the computing device and/or another computing device (e.g., the energy storage controller device) in connection with one or more aspects described herein. Power for operating the thermal management system 140 may be supplied via the auxiliary power system 180 during a grid outage.

The sensors may be capable of measuring or assessing one or more parameters of the BESS modules 110 (A. . . . N). The sensors may include, for example, voltage sensors, current sensors, frequency sensors (e.g., power bus frequency sensors), power sensors (e.g., for measuring the active power or reactive power of an electric grid), or other types of sensors for obtaining measurements associated with the power plant 100. The sensors may have a desired configuration (e.g., shape, size, weight, functionality, etc.). The sensors may be configured to obtain measurements of an electric grid, including the power bus. For example, the sensor may be configured to measure the frequency of alternating current as transmitted via the power bus (e.g., the voltage at the bus bar associated with or included in the power bus), or the sensor may be configured to measure the frequency of alternating current as transmitted via the power bus, e.g., the voltage at the bus bar associated with or included in the power bus. The sensors may be coupled to the electric grid in a desired manner, e.g., by electrically coupling to the points of connection of the electric grid. The sensors may send measured data to the energy storage controller device. It is contemplated that the system may employ one or multiple sensors.

The plant controller 150 for the power plant 100 is composed of a remote terminal unit 150A and a BESS controller 150B. The remote terminal unit 150A is the interface to the customer and an external Supervisory Control and Data Acquisition (SCADA) system 200. The external SCADA system 200 is a computer-based system that monitors and controls industrial processes and equipment. The external SCADA system 200 uses a combination of hardware and software to collect data from devices and equipment, and then applies operational controls over long distances. The external SCADA system 200 may be used to monitor processes, maintain and improve efficiencies, improve quality and profitability, reduce waste, and identify problems and emergencies. Internally, it communicates with the BESS controller 150B and the substation controller 190 by which it operates and monitors the circuit breakers of the power plant 100.

The external SCADA system 200 receives operating commands from the customer and converts them into plant controller-specific and site-specific commands (e.g. start/stop commands, operation modes, breaker operations . . . ). Additionally, it collects operating values of the power plant 100 from the BESS controller 150B and the substation controller 190 and reports them to the customer and the external SCADA system 200. While the remote terminal 150A is project specific by nature, the BESS controller 150B may handle a variety of applications (e.g., frequency control in different markets) and configurations such as different project sizes, power converters and batteries.

The BESS controller 150B processes the commands from the remote terminal 150A, determines the action for each power converter and battery, and controls the power plant's operation at the point of interconnection (POI) 100A.

The plant controller 150, in communication with the substation controller 190 is configured to monitor and control different elements of the plurality of BESS modules 110 (A. . . . N) via module controllers 125, including the respective BESS circuit breakers 155 and the BESS enclosures 120. This includes selectively electrically connecting the plurality of BESS modules 110 (A. . . . N) to the electric grid 170 via the respective BESS circuit breaker 115 and the first and second bus bars 115A, 115B to transfer electric power, which may be related to a charging mode or a discharging mode.

The BESS controller 150B may be organized in different control layers. One layer manages all actions on a plant level, and another layer deals with the control of individual BESS modules, including the control of individual rechargeable BESS enclosures within each BESS module 110 (A. . . . N) via module controllers 125.

The BESS controller 150B communicates with the module controllers 125 arranged to control the plurality of BESS modules 110 (A. . . . N) via communication network 300. Illustrative signals sent to the BESS modules 110 (A. . . . N) may include setpoints, which may include active power (P), reactive power (Q), voltage (V), and/or frequency (f), and BESS operating modes. The BESS operating modes may include, e.g., Disconnected, grid-forming (GFM) operation, and/or grid-following (GFL) operation. Similarly, each BESS module 110 (A. . . . N) reports back to the respective control layer current state information, e.g. State of Charge (SoC), power measurements etc.

The remote terminal 150A may interact with the BESS controller 150B. While the latter is employed to report power plant configurations and connection states of the BESS modules 110 (A. . . . N), the main control interface between the remote terminal 150A and each array 105 is the plant operating mode, e.g., GFL, GFM, Self-Start (SS), and Black-Start (BS).

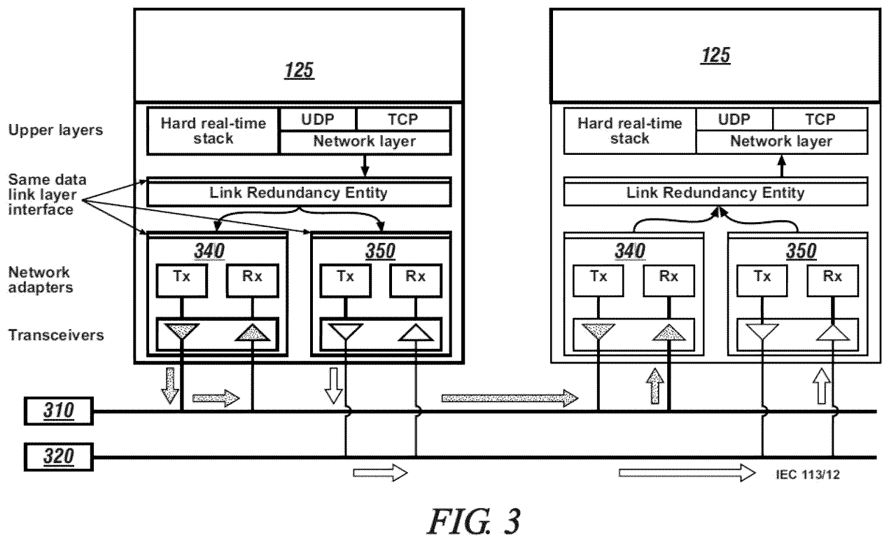

FIG. 3 schematically illustrates elements of the communication network 300, including a redundant local area network (LAN) in communication with module controllers 125 for BESS modules 110. The redundant local area network (LAN) includes first LAN 310 and second LAN 320. The two module controllers 125 include two Dually Attached Nodes (DANs) 330, each having first and second redundant transceivers 340, 350, respectively, which connect to the redundant LANs 310, 320, respectively. The communication network 300 effects communication between the plurality of BESS modules 110 and the BESS controller 150B. The DAN 330 of each of the plurality of BESS modules 110 is in communication with the BESS controller 150B via the first LAN 310 and the second LAN 320.

The communication network 300 executes a parallel redundancy protocol (PRP) to effect communication between the BESS controller 150B and the plurality of BESSs 110. The parallel redundancy protocol (PRP) includes: sending a first message packet from the plant controller to one of the plurality of energy storage modules via the first LAN and a respective one of the DANs, and sending a duplicate of the first message packet from the plant controller to the one of the plurality of energy storage modules via the second LAN and a respective one of the DANs, accepting, at the respective one of the DANs, one of the first message packet or the duplicate of the first message packet from the plant controller, and discarding, at the respective one of the DANs, the other of the first message packet or the duplicate of the first message packet from the plant controller.

The module controller 125 of each of the BESS modules 110 (A. . . . N) communicates externally via DAN 330, which includes a first transmit/receive (or Tx/Rx) port 340 and a second transmit/receive (or Tx/Rx) port 350, which are redundant communication links and are arranged in parallel to effect control of the individual rechargeable BESS enclosures within each of the BESS modules 110 (A. . . . N).

Stated differently, the communication network 300 includes a redundant local area network (LAN) including a first LAN 310 and a second LAN 320 to effect communication between the BESS controller 150B and the respective DANs 330 of the plurality of BESS modules 110 (A. . . . N). The DAN 330 of each of the plurality of BESS modules is in communication with the BESS controller 150B via the first LAN 310, and is also in communication with the BESS controller 150B via the second LAN 320. The communication network 300 executes a parallel redundancy protocol (PRP) to effect communication between the BESS controller 150B and the plurality of module controllers 125 of the plurality of BESS modules 110 (A. . . . N).

The plant controller 150 communicates with one or multiple BESS modules 110 via the communication network 300, and is arranged to monitor and control different elements of the plurality of BESS modules 110, including the respective core circuit breaker (CB Core) and the energy storage module (Core #1. . . X). This includes selectively electrically connecting the plurality of BESS modules 110 to the electric grid via the respective core circuit breaker (CB Core) and the first and second bus bars to transfer electric power, wherein the transfer of electric power may be related to a charging mode or a discharging mode.

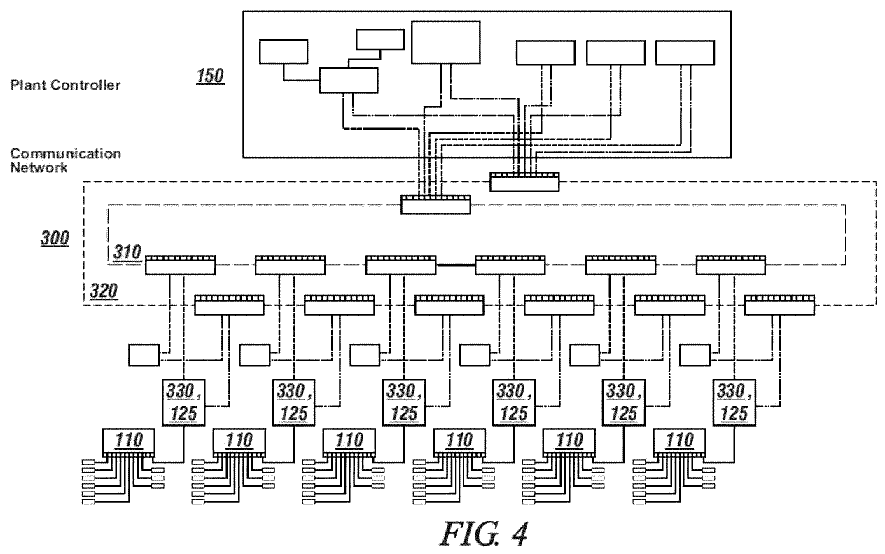

FIG. 4 schematically illustrates elements of the communication network 300 for the energy storage system including a plurality of rechargeable BESS modules arranged in a ring topology. Alternatively, the communication network may be arranged as a star topology or as a ring topology.

Elements of the redundant network architecture of the communication network 300 include redundant network switches/routers, wherein dual network switches or routers are used to create parallel communication paths for each of the BESS modules 110 (A. . . . N). In a dual Ethernet interface, each of the BESS modules 110 (A. . . . N) is equipped with two Ethernet interfaces, with each being connected to a separate network switch/router, thus ensuring redundancy at the physical layer.

Elements of the redundant network architecture of the communication network 300 also include a PRP Protocol Stack in the form of PRP firmware/software. The PRP protocol stack is implemented in the firmware or software running on the BESS units and the network switches/routers. The PRP operates at Layer 2 (data link layer) of the OSI model, providing redundancy by duplicating Ethernet frames over two parallel LANs. The PRP protocol ensures seamless communication even in the event of a network fault by selecting the frame with the lowest sequence number.

Elements of the redundant network architecture of the communication network 300 also include a redundant Control System, including redundant control servers/controllers: Deploy redundant servers or controllers for monitoring and managing the BESS modules 110 (A. . . . N). Redundancy at the control system level ensures continuous operation and automatic failover in case of a fault in the primary system.

Elements of the redundant network architecture of the communication network 300 also include an automatic failover mechanism to switch between redundant paths upon detection of a short term or long-term network fault. This includes continuous monitoring of the health and performance of both network paths to detect faults and trigger failover without manual intervention, and seamless switching between redundant paths to minimize downtime and maintain uninterrupted communication.

Elements of the redundant network architecture of the communication network 300 also include encryption and authentication mechanisms to secure communication between BESS units and the control system.

Elements of the redundant network architecture of the communication network 300 also include access control to control access to network devices and control systems to prevent unauthorized access and protect against cyberthreats.

This arrangement includes Dually Attached Nodes (DANs), which are illustrated with reference to FIG. 3. The DANs are the core devices in a PRP network. Each DAN has two Ethernet ports, each connected to a separate, independent Local Area Network (LAN). The DANs are responsible for transmitting duplicate packets simultaneously on both paths and discarding the second received copy at the destination.

The redundant LANs (LAN A & LAN B) are physically separate and fault-independent Ethernet networks. Preferably, there are no common points of fault, like shared power supplies or cabling routes, to ensure redundancy. Both LANs can have similar topologies (linear, star, ring) depending on network layout.

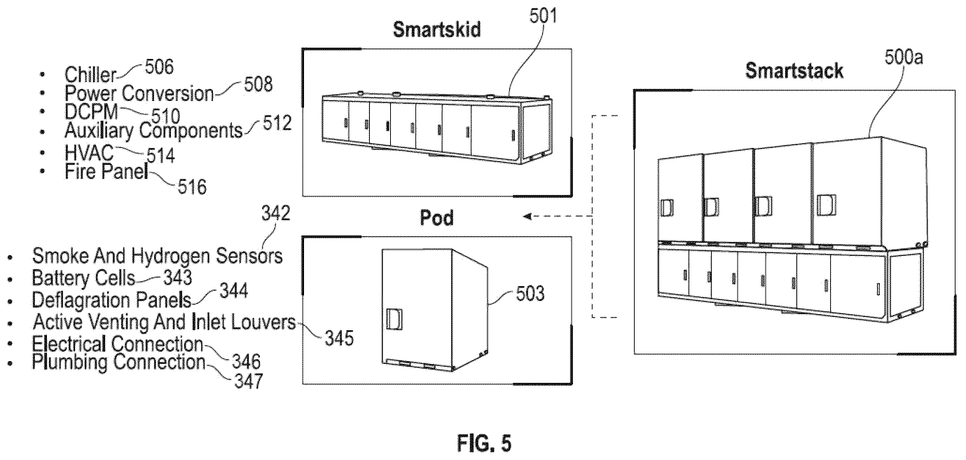

Turning next to FIG. 5, there is shown another example of a representative energy storage system 500a with which aspects of the present disclosure may be practiced. The energy storage system 500a includes a “smartskid” support structure 501 and multiple (e.g., four) battery pods 503 seated on and secured to the smartskid 501. The smartskid 501 of FIG. 5 contains a cooler 508, a power conversion system 508, a DC-DC power module (DCPM) 510, a set of auxiliary skid components 512, an HVAC system 514, and a fire panel 516. Each pod 503 may contain a network of smoke and hydrogen sensors 342, a set of interconnected and rechargeable battery cells 343, multiple deflagration panels 344, active venting and inlet louvers 345, a network of electrical connections 346, and a network of fluid plumbing connections 347.

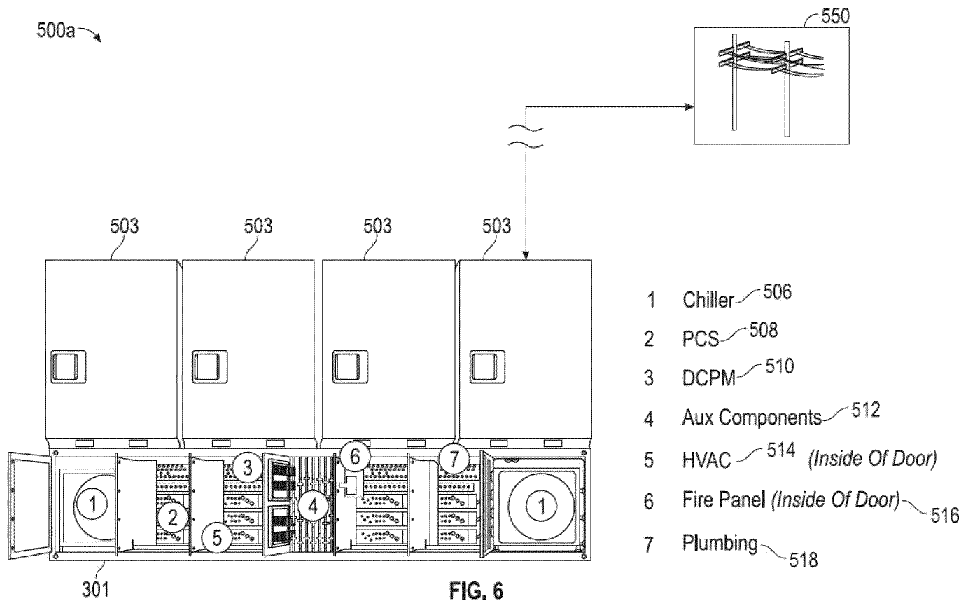

FIG. 6 provides a partially schematic, front-view illustration of the energy storage system 500a shown operatively connected to an external power source 550, such as a utility power grid, renewable energy system, etc. The smartskid 501 of FIG. 6 generally includes two coolers 508, the power conversion system 508, the DCPM 510, the auxiliary components 512, the HVAC system 514, the fire panel 516, and the plumbing 518. The energy storage system 500a may be coupled with the external power source 550. Although differing in appearance, it is envisioned that the energy storage system 500a of FIGS. 5 and 6 may include any of the features and options described above with reference to the power plant 100 of FIG. 1, and vice versa.

Network Devices (Switches & Cables) may be standard network switches that can be used within each LAN (A & B) to connect DANs and other network devices.

All devices on both LANs (DANs, switches) require unique IP addresses within the same subnet prefix, which maintains IP transparency for the redundant paths. Packets can be routed across either LAN without needing IP reconfiguration.

E2E (End to End) is a type of PTP delay measurement scheme in which clock measures delay with regard to the master.

P2P (Peer to Peer) is a type of PTP delay measurement scheme-in which clock measures delay with respect to it's peer, the format for delay measurement scheme differs [between P2P and E2E.

Cycle Time is the time after which the internal nanosecond counter (IEP) re-sets itself. This is also the period for the periodic synchronize signal generated.

OC 1(Ordinary Clock) is a clock that synchronizes its time base to the master.

TC is a Transparent Clock, which is a clock that performs adjustment for packets passing through it.

BMCA (Best Master Clock Algorithm), determines which clock is the highest quality clock within the network.

In one embodiment of the communication network 300, the redundant local area network (LAN) includes a first LAN (local area network A) and a second LAN (local area network B) that redundantly connect between a source and a plurality of destinations. In addition, the first LAN (local area network A) connects to a singly acting node (SAN), and the second LAN (local area network B) connects to a pair of singly acting nodes (SAN).

In one embodiment of the communication network 300, the redundant local area network (LAN) includes a redundant local area network (LAN) including a first LAN (LAN A) and a second LAN (LAN B). A non-PRP-capable device is known as a SAN, Single-Attached Node, and is capable of participating in one of the LAN segments, either LAN A or LAN B. However, if that SAN is attached to a RedBox, it's now capable of participating in PRP similar to a DAN, but it's not a DAN, it's a SAN. This is referred to as a Virtual Double Attached Node, or VDAN.

In one embodiment, the concepts described herein enable an Ethernet network for controlling and monitoring a DC electric energy storage system (BESS) that offers zero-recovery-time redundancy. It achieves this by employing Dually Attached Nodes (DANs) with dual network interfaces connected to separate, independent LANs (LAN A and LAN B). Each DAN transmits duplicate packets simultaneously across both paths. The destination node discards the second received packet, ensuring seamless data flow even during single-path faults.

The Parallel Redundancy Protocol (PRP) provides redundant Ethernet, with each node being connected to two separate, parallel Local Area Networks (LANs). Source nodes send two copies of each packet, one over each network. When a destination node receives a packet, it accepts the first copy and discards the second copy, in other words, eliminating the duplicate.

In operation, the PRP is arranged to send a first message packet from the plant controller to one of the plurality of BESS modules via the first LAN and the first end node of the DAN, and send a duplicate of the first message packet from the plant controller to the one of the plurality of BESS modules via the second LAN and the second end node of the DAN. The DAN accepts one of the first message packet or the duplicate of the first message packet from the plant controller, and discards the other of the first message packet or the duplicate of the first message packet from the plant controller. Furthermore, the parallel redundancy protocol (PRP) is further arranged to monitor the first LAN and the second LAN; and upon detecting a fault in one of the first LAN or the second LAN, discontinue sending the first message packet from the plant controller to the one of the plurality of BESS modules via the one of the first LAN or the second LAN in which the fault has been detected.

The first and second LANs are fault-independent. The destination node will always receive at least one packet as long as either one of the two networks is operational. This provides zero-time recovery in case of a single fault, so no frames are lost. The (PRP) offers several potential advantages, particularly in ensuring high availability, reliability, and fault tolerance in communication networks. The potential advantages include a seamless redundancy by duplicating Ethernet frames over two parallel LANs (Local Area Networks). This redundancy ensures that communication between BESS units and the control system remains uninterrupted even if one network path fails. It eliminates single points of fault in the communication infrastructure, enhancing system reliability. The potential advantages of maintaining parallel communication paths include the PRP ensuring high availability of communication even in the event of network faults. Automatic failover mechanisms detect network faults and switch traffic to the redundant path without causing disruption to BESS operations. This high availability minimizes downtime and ensures continuous operation of the energy storage system. The potential advantages of maintaining parallel communication paths include relatively fast response times in detecting and recovering from network faults. The protocol's mechanisms for duplicate frame detection and selection ensure that the receiving end always receives the most recent and valid data, even if one network path experiences delays or faults. This fast response time is crucial in critical applications where real-time communication is essential.

The potential advantages of maintaining parallel communication paths may include providing redundant paths and automatic failover mechanisms, which may enhance the overall reliability of the BESS system. The parallel communication network reduces the risk of communication faults and data loss, which can lead to operational disruptions or loss of control over the energy storage system. Improved reliability also translates to increased confidence in the system's performance and reduced risk of costly downtime.

The fault-tolerant arrangement ensures that the BESS system remains operational even in the presence of network faults or faults. Redundancy at both the physical and data link layers of the communication network minimizes the impact of faults and increases the system's resilience to disruptions. This fault tolerance is essential in critical infrastructure applications where system faults can have significant consequences.

The potential advantages of maintaining parallel communication paths include scalability and flexibility, with the PRP being scalable and thus may be implemented in networks of various sizes and complexities. Whether deploying a small-scale BESS system or a large-scale grid-connected energy storage project, PRP can accommodate different network architectures and requirements. Its flexibility allows for seamless integration into existing communication infrastructures, minimizing deployment costs and complexity.

The potential advantages of maintaining parallel communication paths include enhanced security via redundancy. Redundant communication paths can mitigate the impact of cyber-attacks or network intrusions by providing alternative routes for data transmission. Additionally, PRP can be combined with robust security measures such as encryption, authentication, and access control to further strengthen system security.

Overall, implementing PRP in an embodiment of the BESS system may provide high availability, reliability, fault tolerance, and system resilience. By ensuring seamless redundancy in communication networks, PRP helps maximize the performance and efficiency of energy storage systems, ultimately contributing to a more stable and reliable power grid.

Embodiments in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may generally be referred to herein as a “module” or “system.” Furthermore, the present disclosure may take the form of a computer program product embodied in a tangible medium of expression having computer-usable program code embodied in the medium.

A combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in a combination of one or more programming languages.

Elements of the system that is described herein may be implemented in a cloud computing environment. In this description and the following claims, “cloud computing” may be defined as a model for enabling ubiquitous, convenient, on-demand network access to a shared pool of configurable computing resources (e.g., networks, servers, storage, applications, and services) that may be rapidly provisioned via virtualization and released with minimal management effort or service provider interaction, and then scaled accordingly. A cloud model may be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A power plant, comprising:
a plurality of DC battery energy storage system (BESS) modules, each BESS module having a dually attached node (DAN);
a plant controller; and
a communication network;
wherein the communication network is linked between the plurality of BESS modules and the plant controller;
wherein the communication network includes a redundant local area network (LAN) arranged with a first LAN and a second LAN;
wherein the DAN of each of the plurality of BESS modules is in communication with the plant controller via the first LAN;
wherein the DAN of each of the plurality of BESS modules is in communication with the plant controller via the second LAN; and
wherein the communication network executes a parallel redundancy protocol (PRP) to effect communication between the plant controller and the plurality of BESS modules via the first and second LANs and the DAN.

2. The power plant of claim 1, wherein each DAN includes a first end node and a second end node; and
wherein the parallel redundancy protocol (PRP) is arranged to:
send a first message packet from the plant controller to one of the plurality of BESS modules via the first LAN and the first end node of the DAN, and send a duplicate of the first message packet from the plant controller to the one of the plurality of BESS modules via the second LAN and the second end node of the DAN,
accept, at the DAN, one of the first message packet or the duplicate of the first message packet from the plant controller, and
discard, at the DAN, the other of the first message packet or the duplicate of the first message packet from the plant controller.

3. The power plant of claim 2, wherein the parallel redundancy protocol (PRP) is further arranged to:
monitor the first LAN and the second LAN; and
upon detecting a fault in one of the first LAN or the second LAN, discontinue sending the first message packet from the plant controller to the one of the plurality of BESS modules via the one of the first LAN or the second LAN in which the fault has been detected.

4. The power plant of claim 1, wherein a network topology for the communication network including the first LAN and the second LAN comprises a linear topology.

5. The power plant of claim 1, wherein a network topology for the communication network including the first LAN and the second LAN comprises a star topology.

6. The power plant of claim 1, wherein a network topology for the communication network including the first LAN and the second LAN comprises a ring topology.

7. The power plant of claim 1, wherein the redundant local area network (LAN) arranged with the first LAN and the second LAN comprises the first LAN being arranged to communicate in parallel with the second LAN.

8. A communication network, the communication network comprising:
a dually attached node (DAN), the DAN being incorporated into a battery energy storage system (BESS) module; and
a redundant local area network (LAN) having a first LAN and a second LAN;
wherein the DAN of the BESS module is in communication with a plant controller via the first LAN; and
wherein the DAN of the BESS module is in communication with the plant controller via the second LAN in parallel with the first LAN.

9. The communication network of claim 8, further comprising the communication network being arranged to execute a parallel redundancy protocol (PRP) to effect communication between the plant controller and the BESS module employing the first LAN and the second LAN.

10. The communication network of claim 8, wherein the DAN includes a first end node and a second end node; and
wherein the parallel redundancy protocol (PRP) is arranged to:
send a first message packet from the plant controller to the BESS module via the first LAN and the first end node of the DAN, and send a duplicate of the first message packet from the plant controller to the BESS module via the second LAN and the second end node of the DAN,
accept, at the DAN, one of the first message packet or the duplicate of the first message packet from the plant controller, and
discard, at the DAN, the other of the first message packet or the duplicate of the first message packet from the plant controller.

11. The communication network of claim 10, wherein the parallel redundancy protocol (PRP) is arranged to:
monitor the first LAN and the second LAN; and
upon detecting a fault in one of the first LAN or the second LAN, discontinue sending the first message packet from the plant controller to the BESS module via the one of the first LAN or the second LAN in which the fault has been detected.

12. The communication network of claim 8, wherein a network topology for the communication network including the first LAN and the second LAN comprises a linear topology.

13. The communication network of claim 8, wherein a network topology for the communication network including the first LAN and the second LAN comprises a star topology.

14. The communication network of claim 8, wherein a network topology for the communication network including the first LAN and the second LAN comprises a ring topology.

15. A method for communicating in a power plant, the method comprising:
arranging a plurality of DC battery energy storage system (BESS) modules, wherein each BESS module has a dually attached node (DAN);
linking, via a communication network, a plant controller to the BESS modules, wherein the communication network includes a redundant local area network (LAN) arranged with a first LAN and a second LAN; and
executing a parallel redundancy protocol (PRP) to effect communication between the plant controller and the plurality of BESS modules via the first and second LANs and the DAN;
wherein the DAN of each of the plurality of BESS modules is in communication with the plant controller via the first LAN; and
wherein the DAN of each of the plurality of BESS modules is in communication with the plant controller via the second LAN.

16. The method of claim 15,
wherein each DAN includes a first end node and a second end node; and
wherein executing the PRP to effect communication between the plant controller and the plurality of BESS modules via the first and second LANs and the DAN comprises:
sending a first message packet from the plant controller to one of the plurality of BESS modules via the first LAN and the first end node of the DAN, and sending a duplicate of the first message packet from the plant controller to the one of the plurality of BESS modules via the second LAN and the second end node of the DAN;
accepting, at the DAN, one of the first message packet or the duplicate of the first message packet from the plant controller; and
discarding, at the DAN, the other of the first message packet or the duplicate of the first message packet from the plant controller.

17. The method of claim 16, wherein executing the PRP to effect communication between the plant controller and the plurality of BESS modules via the first and second LANs and the DAN comprises:
monitoring the first LAN and the second LAN;
detecting a fault in one of the first LAN or the second LAN; and
discontinuing sending the first message packet from the plant controller to the one of the plurality of BESS modules via the one of the first LAN or the second LAN in which the fault has been detected.

18. The method of claim 15, further comprising arranging the communication network with the first LAN and the second LAN in a linear topology.

19. The method of claim 15, further comprising arranging the communication network with the first LAN and the second LAN in a star topology.

20. The method of claim 15, further comprising arranging the communication network with the first LAN and the second LAN in a ring topology.
